(19) United States
(12) Patent Application Publication
(10) Pub. No.: US 2019/0220960 A1
(43) Pub. Date: Jul. 18, 2019

(54) IMAGE ENHANCING WILDLIFE CAMERA

(71) Applicant: Good Sportsman Marketing, LLC, Grand Prarie, TX (US)

(72) Inventors: Howard Unger, Henderson, NV (US); David Anthony, Henderson, NV (US)

(21) Appl. No.: 16/247,959

(22) Filed: Jan. 15, 2019

Related U.S. Application Data
(60) Provisional application No. 62/617,522, filed on Jan. 15, 2018.

(51) Int. Cl. G06T 5/00; G06T 5/50; H04N 5/33

(52) U.S. Cl. CPC G06T 5/009; G06T 5/50; G06T 2207/20221; G06T 2207/10048; H04N 5/332

(57) ABSTRACT

An image enhancing wildlife camera generates enhanced images of animal wildlife in low light conditions. The enhanced images contain details that are traditionally lost due to problematic lighting conditions. The image enhancing wildlife camera includes one or more infrared illuminators that activate upon detection of animal wildlife. An initial image is captured while the animal wildlife is illuminated with an infrared illuminator. The initial image is transformed into an enhanced image using one or more mappings that map color information in the initial image to one or more colors in the visible spectrum.

### CROSS-REFERENCE TO RELATED APPLICATION

This application claims priority to U.S. Provisional Patent Application No. 62/617,522, filed Jan. 15, 2018.

### BACKGROUND OF THE INVENTION

### 1. Field of the Invention

The invention relates to automated image capture devices and in particular to a wildlife camera with low light image enhancement.

### 2. Related Art

Capturing a desired image of animal wildlife is typically difficult and time consuming. Animal wildlife may be skittish, nocturnal or exhibit other characteristics which make image capture problematic. In addition, there are typically few vantage points from which an image of such object can be captured especially in the wild.

From the discussion that follows, it will become apparent that the present invention addresses the deficiencies associated with the prior art while providing numerous additional advantages and benefits not contemplated or possible with prior art constructions.

### SUMMARY OF THE INVENTION

A wildlife camera with low light image enhancement (“image enhancing wildlife camera”) is disclosed herein. The image enhancing wildlife camera generates enhanced images containing details that would traditionally be lost, especially in problematic lighting conditions. This is advantageous where animal wildlife is more commonly present during dawn or dusk hours.

Various embodiments of an image enhancing wildlife camera and methods therefor are disclosed herein. For instance, in one exemplary embodiment, an image enhancing wildlife camera comprises one or more sensors that detect animal wildlife, one or more infrared illuminators that emit infrared light upon detection of the animal wildlife by the sensors during a first lighting condition, and one or more second illuminators that emit visible light upon detection of the animal wildlife by the sensors during a second lighting condition.

One or more imaging devices that capture one or more initial images of the animal wildlife illuminated by the infrared illuminators during the first lighting condition, or one or more normal images of the animal wildlife illuminated by the second illuminators during the second lighting condition are also included. One or more processors transform the initial images into one or more enhanced images utilizing one or more mappings. The enhanced images include colors that are not in the initial image.

The image enhancing wildlife camera may include a light sensor that detects the first lighting condition, the second lighting condition, or both. Alternatively, or in addition, a clock that identifies the first lighting condition, the second lighting condition, or both may be provided.

The mappings may comprise a mapping of a first set of color information to a second set of color information. In addition, the infrared light may be of a spectrum that is not visible to the animal wildlife. It is noted that the first lighting condition may be a low lighting condition. One or more storage devices may store the normal images and the enhanced images.

In another exemplary embodiment, an image enhancing wildlife camera comprises one or more sensors that detect animal wildlife, one or more infrared illuminators that emit infrared light upon detection of the animal wildlife by the sensors during a first lighting condition, and one or more imaging devices that capture one or more initial images of the animal wildlife illuminated by the infrared illuminators during the first lighting condition, or one or more normal images of the animal wildlife during a second lighting condition. One or more processors transform the initial images into one or more enhanced images utilizing one or more mappings, wherein the enhanced images include colors that are not in the initial image.

One or more second illuminators that emit visible light upon detection of the animal wildlife during the second lighting condition may be included as well. Similar to the above embodiment, a light sensor or clock that detects or identifies the first lighting condition, the second lighting condition, or both may be provided.

The mappings may comprise a mapping of a first set of color information to a second set of color information. In addition, the infrared light is of a spectrum that is not visible to the animal wildlife. It is noted that the first lighting condition may be a low lighting condition in one or more embodiments.

In yet another exemplary embodiment, a method for capturing images of animal wildlife with an image enhancing wildlife camera is disclosed, the method comprising detecting animal wildlife with one or more sensors and identifying a first lighting condition or a second lighting condition.

During the first lighting condition and upon detection of the animal wildlife, infrared light is emitted from one or more infrared illuminators and capturing one or more initial images of the animal wildlife illuminated by the infrared light with one or more imaging devices. During the second lighting condition and upon detection of the animal wildlife, one or more normal images of the animal wildlife are captured. The initial images are transformed into one or more enhanced images utilizing one or more mappings, such as by one or more processors, wherein the enhanced images include colors that are not in the initial image.

It is noted that visible light may be emitted from one or more second illuminators upon detection of the animal wildlife during the second lighting condition. The first lighting condition, the second lighting condition, or both may be detected or identified with a light sensor or clock. The mappings may comprise a mapping of a first set of color information to a second set of color information. In addition, the infrared light may be of a spectrum that is not visible to the animal wildlife.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 illustrates an exemplary environment of use for an image enhancing wildlife camera;

FIG. 2 is a front view of an exemplary image enhancing wildlife camera;

FIG. 3 is a flow diagram illustrating operation of an exemplary image enhancing wildlife camera;

FIG. 4 is a block diagram illustrating components of an exemplary image enhancing wildlife camera; and

FIG. 5 is a block diagram illustrating transformation of an exemplary initial image.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Particular types of animal wildlife can be more readily found during dawn or dusk. During such times, lighting conditions are typically not ideal for capturing images. The image enhancing wildlife camera disclosed herein is capable of automatically capturing images of wildlife while enhancing such images according to various predefined criteria. In this manner, the image enhancing wildlife camera provides images with enhanced detail, such as enhanced color information, even in low light or other problematic lighting conditions.

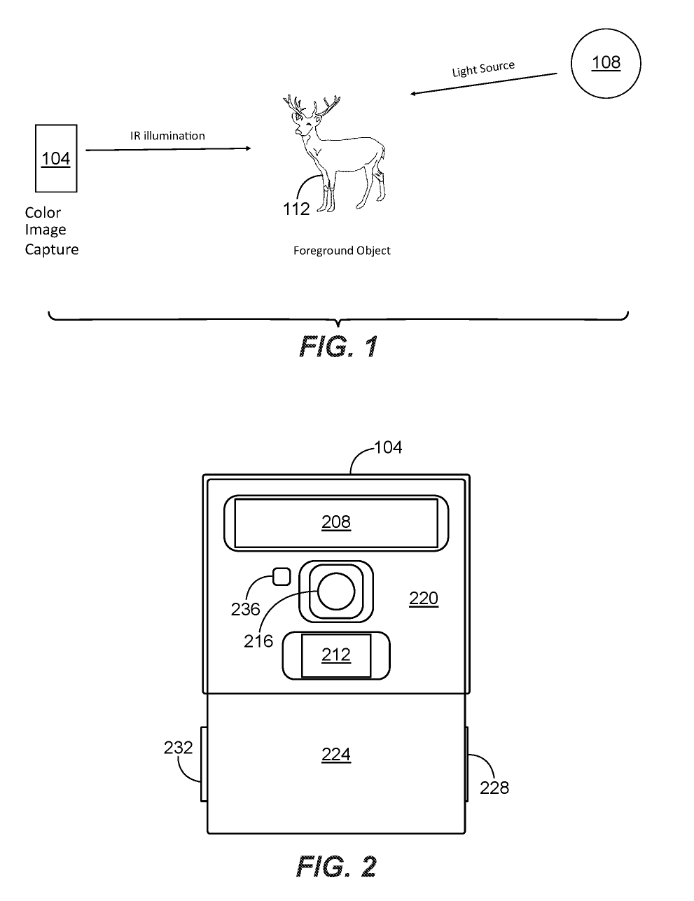

FIG. 1 illustrates an exemplary environment of use having a problematic lighting condition. Namely, animal wildlife 112 is positioned between a light source 108 and an image enhancing wildlife camera 104. An ideal image of the animal wildlife 112 would typically include detailed color information relating to the animal wildlife. Traditionally, in a lighting condition where the object to be captured is in the foreground with the main light source in the background, significant loss of color information would occur with respect to the foreground object. The foreground object would appear dark with very little color information.

This lighting condition is present during dawn and dusk, when animal wildlife 112 is commonly present. As illustrated in FIG. 1 for example, the light source 108, in this case the sun, is low on the horizon during dawn and dusk which causes light to shine directly at an image enhancing wildlife camera 104. A similar situation exists when the light source 108 behind animal wildlife 112 is the moon. Whereas a traditional camera would lose many of the details present in a foreground object, such as the animal wildlife 112 as shown, the image enhancing wildlife camera 104 captures additional information to allow such details to be preserved or restored during an image enhancement process.

FIG. 2 illustrates an exemplary image enhancing wildlife camera 104. As can be seen, an image enhancing wildlife camera 104 may comprise one or more imaging devices 216, one or more object sensors 212, and one or more infrared illuminators 208. Components of an image enhancing wildlife camera 104, such as the foregoing, may be housed within an enclosure 220. An enclosure 220 will typically provide protection from moisture, such as by being sealed. One or more compartments 224 may be part of an enclosure 220 and may be made accessible via one or more hinges 228, one or more latches 232, or both. It is contemplated that one or more power sources, such as batteries, storage devices, or both may be accessed, removed, or replaced by opening a compartment 224.

Typically, an image enhancing wildlife camera 104 will be installed in an outdoor environment, such as shown in FIG. 1. For example, an image enhancing wildlife camera 104 may be attached to a tree, building, or other outdoor structure, such as by one or more mounts. In this manner, an image enhancing wildlife camera 104 can be positioned at locations where animal wildlife can be detected and captured by an imaging device 216 thereof.

An object sensor 212 will typically be used to detect animal wildlife that is present within the field of view of an image enhancing wildlife camera's imaging device 216. Some exemplary object sensors 212 include infrared sensors that may operate in a passive or active manner, motion sensors, radiofrequency sensors, audio sensors, and vibration sensors. In operation, an object sensor 212 will detect a condition or conditions indicative of the presence of animal wildlife, and output a signal indicating the same. For example, an infrared object sensor may detect the presence of animal wildlife based on the heat emitted by the animal wildlife and output a corresponding signal. It is noted that an object sensor 212 may be selected or calibrated to detect people, various types of wildlife, inanimate objects, or various combinations thereof as desired. If animal wildlife (or other object) is not detected, an object sensor 212 may output no signal or a distinct signal indicating the same.

In response to output from one or more object sensors 212, one or more imaging devices 216 and one or more infrared illuminators 208 may be activated to capture an enhanced image. An imaging device 216 will typically be a camera or other device capable of capturing images. In one or more embodiments, an imaging device 216 will capture wavelengths beyond the visible light spectrum. For example, an imaging device 216 may capture only the infrared spectrum emitted by an image enhancing wildlife camera's infrared illuminators 208.

In some embodiments, an imaging device 216 will not capture visible or other wavelengths and will therefore be limited to capturing infrared wavelengths. In other embodiments, an imaging device 216 may capture visible or other wavelengths in addition to infrared wavelengths. It is contemplated that a plurality of imaging devices 216 may be provided in some embodiments, with individual imaging devices capturing distinct range(s) of wavelengths.

An infrared illuminator 208 will typically emit infrared light when activated. An infrared illuminator may comprise one or more infrared LED (light emitting diodes), light bulbs, or other infrared emitting devices. In one or more embodiments, an infrared illuminator 208 will emit infrared light at one or more particular wavelengths or within a predefined range, which may be a subset of the overall infrared spectrum.

The particular wavelengths or range may be selected based on the animal wildlife to be captured. For instance, an infrared illuminator 208 may emit infrared light at one or more wavelengths not visible to the particular animal wildlife to be captured so as to not spook or scare the animal wildlife. This may be adjusted based on the type of animal wildlife to be captured.

An image enhancing wildlife camera 104 may also include one or more light sensors 236 that detect light levels. A light level below a particular threshold may be used to determine that a problematic lighting condition exists, as will be described further below. Alternatively, it is contemplated that an imaging device 216 may be used to detect light levels and problematic lighting conditions. As such, a light sensor 236 need not be included in all embodiments of the image enhancing wildlife camera 104.

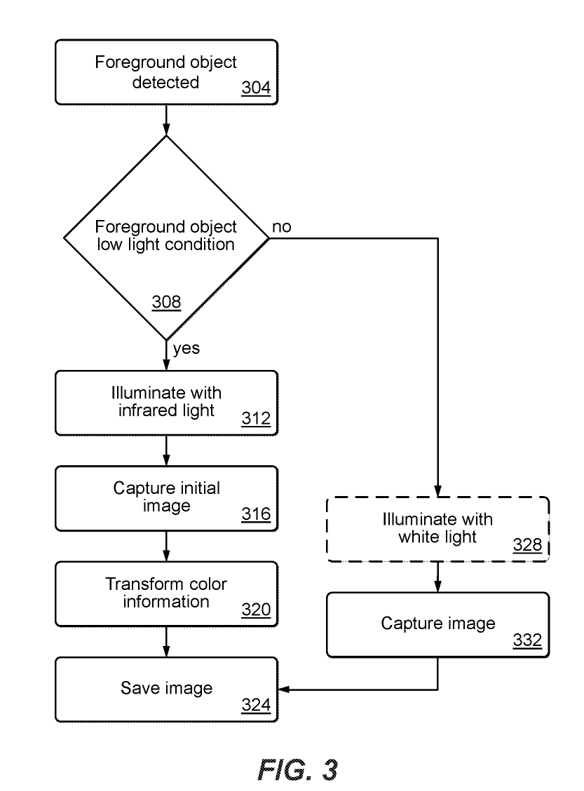

FIG. 3 is a flow diagram illustrating operation of an exemplary image enhancing wildlife camera. Though illustrated and described according to a particular sequence, it is contemplated that various steps of the operation of an image enhancing wildlife camera may occur according to distinct sequences. For example, an object detection step may occur subsequent to detection of a low light condition, or vice versa.

At a step 304, a foreground object is detected by an object sensor of an image enhancing wildlife camera. As described above, a foreground object will typically be animal wildlife to be captured by an image enhancing wildlife camera. In response, the object sensor outputs a signal indicating that animal wildlife has been detected. To illustrate, if an animal were to walk, fly, crawl, or otherwise move within view of an object sensor, such object sensor would output a signal indicating the same. It is noted that, if no animal or other object is detected, a distinct signal or no signal may be generated.

At a decision step 308, it is determined if a problematic lighting condition exists. As shown in FIG. 3 for example, a problematic lighting condition may be a low light condition. A problematic lighting condition may be detected by one or more imaging devices of an image enhancing wildlife camera. Alternatively, one or more light sensors may be provided to determine if a low light condition exists.

A problematic lighting condition may be determined to exist if detected light levels are below a particular threshold. Alternatively, a problematic lighting condition may be determined to exist at one or more predefined periods of time during a day. For example, problematic lighting conditions may be defined at the times of dawn and dusk.

If a problematic lighting condition exists, one or more infrared illuminators may be activated at a step 312. This illuminates the detected animal wildlife with infrared light. An initial image of the animal wildlife may then be captured at a step 316. The initial image will typically be an infrared image of the animal wildlife and its surroundings. Accordingly, such initial image will not include visible wavelength information, or will represent the animal wildlife and its surroundings with a subset of the visible or other light spectrum. For example, the initial image may be an image comprising a lightness (or darkness) value for each pixel, with no or little color frequency information, such as in the case of a grayscale image.

At a step 320, the initial image may be converted into an enhanced image. As will be described further below, information in the initial image may be transformed to generate an enhanced image including or consisting only of colors in the visible spectrum. In such manner, the spectrum range in the initial image is substantially expanded during step 320 to generate an enhanced image including or consisting only of colors in the visible spectrum. In such manner, the enhanced image appears similar to a traditional photograph but with enhanced color information for the foreground object (i.e., the detected animal wildlife), which would traditionally appear as a darkened silhouette with very little color information.

At a step 324, the enhanced image may be saved, such as on a storage device. It is contemplated that the initial image may also be saved as well in some embodiments.

Referring back to decision step 308, if a problematic lighting condition is not detected, animal wildlife, or other foreground object, may be illuminated with a distinct light. As illustrated in FIG. 3 for instance, illumination occurs with white light at a step 328. Illumination when a problematic lighting condition does not exist is option, as indicated by the broken line representation of step 328.

At a step 332, a normal color image of the animal wildlife may be captured. Such normal color image may be a traditional visible light color image in one or more embodiments. It is contemplated that a normal color image may be captured by a distinct imaging device included for such purposes. Alternatively, an imaging device of an image enhancing wildlife camera may be configured to capture images at distinct light spectrums separately. A normal color image may be saved, such as on a storage device, at step 324.

It is contemplated that an image enhancing wildlife camera may operate in different modes. In one or more embodiments for example, an image enhancing wildlife camera may operate in time lapse mode whereby an infrared illuminator and imaging device are activated at a predefined interval of time. Initial images captured in this manner can be automatically transformed or converted to enhanced images as described herein.

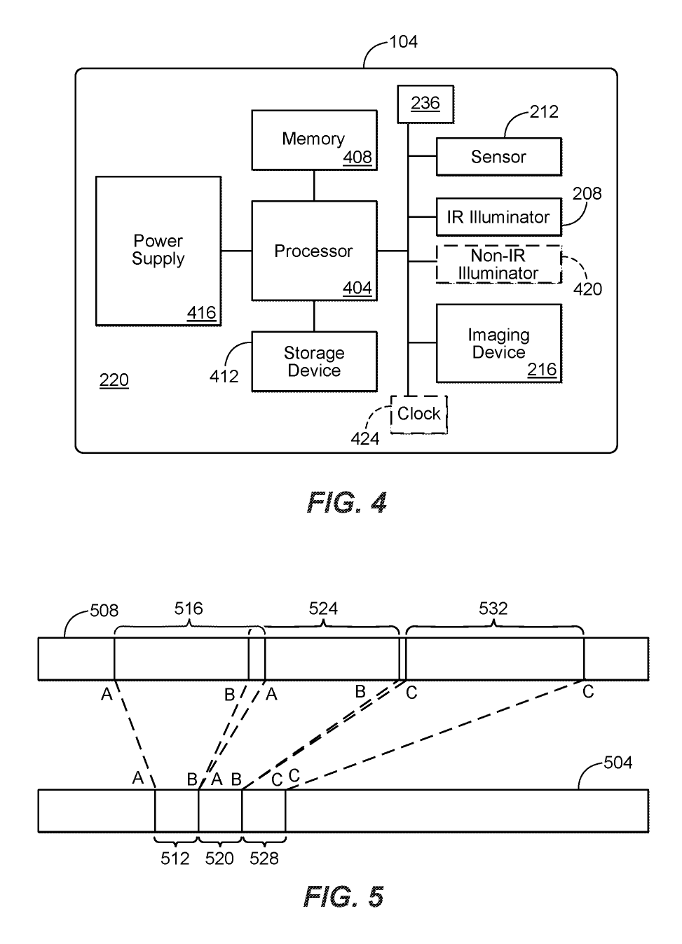

FIG. 4 is a block diagram illustrating components of an exemplary image enhancing wildlife camera 104. As described above, an image enhancing wildlife camera 104 may comprise one or more imaging devices 216, one or more infrared imaging devices 208, and one or more object sensors 212. In addition, one or more light sensors 236 may be included.

Internally, an image enhancing wildlife camera 104 may comprise one or more processors 404, one or more memory devices 408, and one or more storage devices 412. One or more power supplies 416 may also be provided to power an image enhancing wildlife camera 104. For example, a power supply 416 may comprise one or more batteries, drivers, adapters, or the like. A power supply 416 may be powered or charged by an external source, such as utility power.

A processor 404 may be a microprocessor, integrated circuit, or other electronic circuitry/componentry that provides the functionality disclosed herein. A processor 404 may execute instructions to provide such functionality. The instructions may be machine readable code stored on a non-transient storage device 412 (excluding carrier waves and signaling). Alternatively, or in addition, the instructions may be hardwired in the circuitry of a processor 404.

A processor 404 may include or access a memory device 408 during operation. For example, a memory device 408 may be used to cache instructions or various data used by a processor 404 during its operation.

A storage device 412 will typically be provided to store images for an image enhancing wildlife camera 104. This includes initial images, enhanced images, and normal color images. Some exemplary storage devices 412 include flash memory, magnetic drives, optical drives, and solid state drives. As described above, a storage device 412 may have removable media.

In operation, a processor 404, may communicate with various components of an image enhancing wildlife camera 104. For instance, a processor 404 may receive light levels from a light sensor 236, signals from an object sensor 212, and images from an imaging device 216. A processor 404 may activate or transmit signals to activate an infrared illuminator 208 and imaging device 216 such as when a light level is below a particular threshold and animal wildlife has been detected, as disclosed above with regard to FIG. 3. In addition, a processor may process initial images to generate enhanced images, as will be described further below.

As shown, an image enhancing wildlife camera 104 may optionally include a non-infrared illuminator, such as a white light illuminator 420 in some embodiments. A processor 404 may optionally activate a white light illuminator 420 when problematic lighting conditions are not present, such as described above with regard to FIG. 3. An imaging device 216 may be activated by a processor 404 to capture a normal color image as well.

A timer or clock 424 may optionally be provided in some embodiments to provide time information including the time or an indication of when a particular period of time has passed. A clock 424 may be used to operate an image enhancing wildlife camera 104 in a time lapse mode whereby an infrared illuminator 208 and imaging device 216 are activated repeatedly at a predefined interval of time to capture a number or set of initial images. For example, initial images may be captured every five minutes (or other time period) regardless of whether animal wildlife or other foreground object has been detected. The initial images are then converted or transformed to generate enhanced images, which form a time lapse of the area in the imaging device's view.

It is contemplated that a clock 424 may be used to identify dawn and dusk as well, such as to identify a low light or other problematic lighting conditions as described above with regard to FIG. 3. When a foreground object is in such condition, it may be illuminated with infrared light before being captured in an initial images, as described above.

FIG. 5 illustrates a first color spectrum 504 and a second color spectrum 508. Sections 512, 520, 528 represent color information from an initial image, while sections 516, 524, 532 represent color information from an enhanced image. As can be seen, the color information in the enhanced image covers a larger variety of the color spectrum (e.g., the visible light spectrum), even though it is generated from color information of the initial image's limited color information.

As set forth above, an initial image's color information is limited because an initial image may contain color information having only brightness/darkness information for each pixel in some situations generated from an infrared camera image. Alternatively, or in addition, an initial image may have color information limited to a particular subset of the light spectrum, such as the infrared spectrum.

In operation, a particular section or range of color information may be transformed into another section or range of color information. As shown in FIG. 5 for example, a first section 512 of color information may be transformed or mapped to a second section 516. A first section 512 and a second section 516 may be in a different color space or spectrum. For example, in the exemplary embodiment of FIG. 5, the first section 512 may contain a first range of color information, such as brightness in a grayscale image that is mapped to a second section 516, which is a distinct portion of a visible color spectrum.

Likewise, a third section 520 of the initial images color information may be mapped to a fourth section 524, which is a distinct portion of the visible color spectrum. As can be seen via the mapping of sections 512, 520 to sections 516, 524, respectively, the mapping between an initial image's color information to that of an enhanced image may overlap. An n^{th} section 528 of an initial images' color information may be mapped to a n^{th} section 532 of an enhanced image's color information. In this manner, a grayscale color information or other limited color information, can be mapped to various combinations of red, green, and blue to generate an enhanced image possessing colors in the visible spectrum.

It is contemplated that one or more predefined mappings may be provided for the range of color information in an initial image. For example, in an initial image having color information corresponding to 256 levels of brightness, various subsets of these levels may be associated with particular colors in the visible color spectrum. Such mapping may be stored on a storage device of an image enhancing wildlife camera.

It is contemplated that a plurality of mappings may be provided and selectively used to transform or convert an initial image into an enhanced image. Various factors may govern the selection of a particular mapping. For example, a particular light level, time of day, or other factor may cause a particular mapping of a plurality of mappings to be selected for use. In this manner, generation of an enhanced image can be controlled to compensate for light levels or other environmental characteristics. It is contemplated that a user may input information regarding the colors in an environment, or that a natural color calibration image may be captured to fine tune one or more mappings.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. An image enhancing wildlife camera comprising:
one or more sensors that detect animal wildlife;
one or more infrared illuminators that emit infrared light upon detection of the animal wildlife by the one or more sensors during a first lighting condition;
one or more second illuminators that emit visible light upon detection of the animal wildlife by the one or more sensors during a second lighting condition;
one or more imaging devices that capture one or more initial images of the animal wildlife illuminated by the one or more infrared illuminators during the first lighting condition, or one or more normal images of the animal wildlife illuminated by the one or more second illuminators during the second lighting condition; and
one or more processors that transform the one or more initial images into one or more enhanced images utilizing one or more mappings, wherein the one or more enhanced images include colors that are not in the initial image.

2. The image enhancing wildlife camera of claim 1, further comprising a light sensor that detects the first lighting condition, the second lighting condition, or both.

3. The image enhancing wildlife camera of claim 1, further comprising a clock that identifies the first lighting condition, the second lighting condition, or both.

4. The image enhancing wildlife camera of claim 1, wherein the one or more mappings comprise a mapping of a first set of color information to a second set of color information.

5. The image enhancing wildlife camera of claim 1, wherein the infrared light is of a spectrum that is not visible to the animal wildlife.

6. The image enhancing wildlife camera of claim 1, wherein the first lighting condition is a low lighting condition.

7. The image enhancing wildlife camera of claim 1, further comprising one or more storage devices that store the one or more normal images and the one or more enhanced images.

8. An image enhancing wildlife camera comprising:
one or more sensors that detect animal wildlife;
one or more infrared illuminators that emit infrared light upon detection of the animal wildlife by the one or more sensors during a first lighting condition;
one or more imaging devices that capture one or more initial images of the animal wildlife illuminated by the one or more infrared illuminators during the first lighting condition, or one or more normal images of the animal wildlife during a second lighting condition; and
one or more processors that transform the one or more initial images into one or more enhanced images utilizing one or more mappings, wherein the one or more enhanced images include colors that are not in the initial image.

9. The image enhancing wildlife camera of claim 8, further comprising one or more second illuminators that emit visible light upon detection of the animal wildlife during the second lighting condition.

10. The image enhancing wildlife camera of claim 8, further comprising a light sensor that detects the first lighting condition, the second lighting condition, or both.

11. The image enhancing wildlife camera of claim 8, further comprising a clock that identifies the first lighting condition, the second lighting condition, or both.

12. The image enhancing wildlife camera of claim 8, wherein the one or more mappings comprise a mapping of a first set of color information to a second set of color information.

13. The image enhancing wildlife camera of claim 8, wherein the infrared light is of a spectrum that is not visible to the animal wildlife.

14. The image enhancing wildlife camera of claim 8, wherein the first lighting condition is a low lighting condition.

15. A method for capturing images of animal wildlife with an image enhancing wildlife camera, the method comprising:
detecting animal wildlife with one or more sensors;
identifying a first lighting condition or a second lighting condition;
during the first lighting condition and upon detection of the animal wildlife, emitting infrared light from one or more infrared illuminators and capturing one or more initial images of the animal wildlife illuminated by the infrared light with one or more imaging devices;
during the second lighting condition and upon detection of the animal wildlife, capturing one or more normal images of the animal wildlife; and
transforming the one or more initial images into one or more enhanced images utilizing one or more mappings, wherein the one or more enhanced images include colors that are not in the initial image.

16. The method of claim 15, further comprising emitting visible light from one or more second illuminators that upon detection of the animal wildlife during the second lighting condition.

17. The method of claim 15, further comprising detecting the first lighting condition, the second lighting condition, or both with a light sensor.

18. The method of claim 15, further comprising identifying the first lighting condition, the second lighting condition, or both with a clock.

19. The method of claim 15, wherein the one or more mappings comprise a mapping of a first set of color information to a second set of color information.

20. The method of claim 15, wherein the infrared light is of a spectrum that is not visible to the animal wildlife.
